(19) United States
(12) Patent Application Publication
(10) Pub. No.: US 2020/0110404 A1
(43) Pub. Date: Apr. 9, 2020

(54) LEFT-BEHIND BELONGINGS DELIVERY SUPPORT APPARATUS, LEFT-BEHIND BELONGINGS DELIVERY SUPPORT SYSTEM, AND LEFT-BEHIND BELONGINGS DELIVERY SUPPORT METHOD

(71) Applicant: TOYOTA JIDOSHA KABUSHIKI KAISHA, Toyota-shi (JP)

(72) Inventors: Takahiro SHIGA, Chiryu-shi (JP); Mami KATO, Toyota-shi (JP); Masato ENDO, Nagakute-shi (JP)

(73) Assignee: TOYOTA JIDOSHA KABUSHIKI KAISHA, Toyota-shi (JP)

(21) Appl. No.: 16/531,213

(22) Filed: Aug. 5, 2019

(30) Foreign Application Priority Data
Oct. 5, 2018 (JP) 2018-190101

(51) Int. Cl. G05D 1/00; G06Q 10/08

(52) U.S. Cl. CPC G05D 1/0022; G05D 2201/0213; G05D 2201/0212; G06Q 10/08355

(57) ABSTRACT

A left-behind belongings delivery support apparatus includes a communication device configured to be able to communicate with a vehicle-mounted device installed in a vehicle that is under automatic driving control and a mobile terminal of a user of the vehicle; and a processor configured to send, when a request for delivery of belongings left behind in the vehicle is received from the mobile terminal through the communication device, a movement command for moving the vehicle to a delivery destination of the left-behind belongings, to the vehicle-mounted device through the communication device.

### FIELD

The present invention relates to a left-behind belongings delivery support apparatus, a left-behind belongings delivery support system, and a left-behind belongings delivery support method that support the delivery of personal belongings left behind in a vehicle.

### BACKGROUND

In recent years, automatic driving technologies with the aim of realizing mobility services such as taxi, bus, and ride sharing services using automatic driving vehicles that are driven under automatic driving control have been developed.

For example, a non-patent literature (TOYOTA MOTOR CORPORATION, Mobility Service-specific EV “e-Palette Concept” [retrieved on Aug. 31, 2018], Internet <URL: https://newsroom.toyota.co.jp/jp/corporate/20508200.html>) describes a vehicle that enables a manufacturer other than the maker of the vehicle to develop an automatic driving kit including software for automatic driving control for the vehicle, by disclosing a vehicle control I/F (interface) for controlling the vehicle. Since the automatic driving kit is configured to be replaceable or updatable, the automatic driving control can be optimized in conformance with Mobility-as-a-Service (MaaS) in the fields of movement, logistics, product sales, and the like.

Although automatic driving vehicles have the advantage that crew members such as drivers are unnecessary, the automatic driving vehicles also have the disadvantage that, for example, if a user exits the vehicle leaving behind belongings, there are no crew members to find such belongings and inform the user as such. In the technology described in Japanese Patent Publication (Kokai) No. 2013-191053, for example, the current state of the interior of a vehicle is captured as current video data, and the current video data is compared with comparison video data stored in advance. When any difference is detected therebetween, a change of the interior of the vehicle is inspected, and a predetermined message is sent to the interior of the vehicle based on the difference, in order to warn a user to take his or her belongings.

### SUMMARY

However, in taxi, bus, and ride sharing services in which a plurality of users ride in a vehicle, it is difficult, using the technology described in Japanese Patent Publication (Kokai) No. 2013-191053, to distinguish between personal belongings left behind by a user who has exited the vehicle and the personal belongings of passengers who are still riding in the vehicle. When the user has exited the vehicle in a hurry, the user may be unaware of a warning about the belongings. Therefore, there is a problem that significant time is required for the user to retrieve his or her belongings left behind in the vehicle via a lost-and-found office or the like.

The present invention aims to provide a left-behind belongings delivery support apparatus that supports the delivery of personal belongings left behind in a vehicle.

A left-behind belongings delivery support apparatus according to an embodiment of the present invention includes a communication device configured to be able to communicate with a vehicle-mounted device installed in a vehicle that is under automatic driving control and a mobile terminal of a user of the vehicle; and a processor configured to send, when a request for delivery of belongings left behind in the vehicle is received from the mobile terminal through the communication device, a movement command for moving the vehicle to a delivery destination of the left-behind belongings, to the vehicle-mounted device through the communication device.

In the left-behind belongings delivery support apparatus, upon receiving the delivery request, the processor preferably sends a command for making the vehicle-mounted device send an image of an interior of the vehicle, to the vehicle-mounted device through the communication device, whereby the processor preferably receives the image from the vehicle-mounted device through the communication device, and sends the received image to the mobile terminal through the communication device.

In the left-behind belongings delivery support apparatus, when the processor receives a left-behind belongings notification indicating that the left-behind belongings have been detected in the vehicle from the vehicle-mounted device through the communication device, the processor preferably sends the left-behind belongings notification to the mobile terminal through the communication device.

In the left-behind belongings delivery support apparatus, the left-behind belongings notification is preferably issued when the left-behind belongings are stored in a lost-and-found box, and the left-behind belongings notification preferably includes an image of the inside of the lost-and-found box and a password to unlock the lost-and-found box.

In the left-behind belongings delivery support apparatus, when the processor receives the delivery request, before receiving the left-behind belongings notification, the processor preferably sends a command to let the vehicle-mounted device provide guidance for storing the left-behind belongings in the lost-and-found box to the vehicle-mounted device through the communication device.

In the left-behind belongings delivery support apparatus, when the processor receives a command for discarding the left-behind belongings from the mobile terminal through the communication device, the processor preferably does not send the movement command to the vehicle-mounted device.

A left-behind belongings delivery support system according to an embodiment of the present invention includes a vehicle-mounted device installed in a vehicle that is under automatic driving control, a mobile terminal of a user of the vehicle, and a server communicatably connected to the vehicle-mounted device and the mobile terminal through a network. The mobile terminal sends a request for delivery of belongings left behind in the vehicle to the server. Upon receiving the delivery request, the server sends a movement command for moving the vehicle to a delivery destination of the left-behind belongings to the vehicle-mounted device. Upon receiving the movement command, the vehicle-mounted device moves the vehicle to the delivery destination of the left-behind belongings.

A left-behind belongings delivery support method according to an embodiment of the present invention includes the steps of, through a communication device configured to be able to communicate with a vehicle-mounted device installed in a vehicle that is under automatic driving control and a mobile terminal of a user of the vehicle, receiving a request for delivery of belongings left behind in the vehicle from the mobile terminal through the communication device; and thereafter sending a movement command to move the vehicle to a delivery destination of the left-behind belongings, to the vehicle-mounted device through the communication device.

The object and advantages of the invention will be realized and attained by means of the elements and combinations particularly pointed out in the claims. It is to be understood that both the foregoing general description and the following detailed description are exemplary and explanatory, and are not restrictive of the invention, as claimed.

### BRIEF DESCRIPTION OF DRAWINGS

FIG. 1 is a drawing showing an example of the configuration of a left-behind belongings delivery support system according to a first embodiment.

FIG. 2 is a sequence diagram showing an example of a left-behind belongings delivery process for moving a vehicle to a delivery destination of left-behind belongings, in the left-behind belongings delivery support system according to the first embodiment.

FIG. 3 is a drawing showing an example of the state of a compartment of the vehicle according to the first embodiment.

FIG. 4 is a hardware configuration diagram of the vehicle according to the first embodiment.

FIG. 5 is a hardware configuration diagram of a server according to the first embodiment.

FIG. 6 is a functional block diagram of a controller of the server according to the first embodiment.

FIG. 7 is a flowchart showing an example of the left-behind belongings delivery process for moving the vehicle to the delivery destination of the left-behind belongings, in the server according to the first embodiment.

FIG. 8 is a flowchart showing another example of the left-behind belongings delivery process for moving the vehicle to the delivery destination of the left-behind belongings, in the server according to the first embodiment.

FIG. 9 is a hardware configuration diagram of a mobile terminal according to the first embodiment.

### DESCRIPTION OF EMBODIMENTS

A left-behind belongings delivery support apparatus according to the present invention includes a communication device that is configured to be able to communicate with a vehicle-mounted device installed in a vehicle that is under automatic driving control and a mobile terminal of a user of the vehicle. Upon receiving a request for delivery of belongings left behind in the vehicle through the communication device, the left-behind belongings delivery support apparatus sends a movement command to move the vehicle to a delivery destination of the left-behind belongings, to the vehicle-mounted device through the communication device.

Therefore, by moving the vehicle that is under automatic driving control to the delivery destination of the left-behind belongings, the left-behind belongings delivery support apparatus according to the present invention can support the quick delivery of the belongings left behind in the vehicle to the user.

A preferred embodiment of the present invention will be described below with reference to the drawings. Note that, the present invention is not limited to the following embodiment, but may be appropriately modified without departing from the gist thereof. In the drawings, components having the same or similar functions have been assigned the same reference numerals, and descriptions thereof may be omitted or simplified.

### First Embodiment

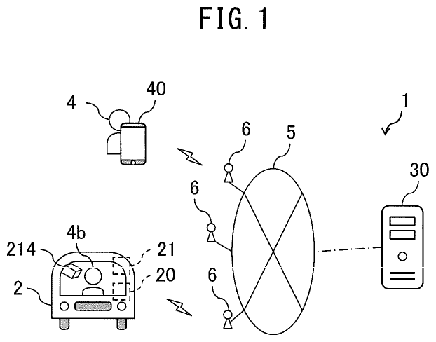

FIG. 1 is a drawing showing an example of the configuration of a left-behind belongings delivery support system 1 according to a first embodiment. The left-behind belongings delivery support system 1 according to the present embodiment includes a vehicle-mounted device 20, a server 30, and a mobile terminal 40. The server 30 is an example of the left-behind belongings delivery support apparatus.

The vehicle 2 illustrated in FIG. 1 is an automatic driving vehicle that offers mobility services such as taxi, bus, or ride sharing services. When a user 4 who has moved to his or her destination using the mobility service offered by the vehicle 2 becomes aware of his or her belongings left behind in the vehicle 2 after he or she has exited the vehicle 2, the user 4 operates the mobile terminal 40, such as a cellular phone or a tablet computer, to send a request for delivery of the left-behind belongings to the server 30.

Upon receiving the request for delivery of the belongings left behind in the vehicle 2 from the mobile terminal 40, the server 30 sends a movement command for moving the vehicle 2 to a delivery destination of the left-behind belongings to the vehicle-mounted device 20.

Another passenger 4b using the mobility service rides in the vehicle 2. The vehicle-mounted device 20 and an automatic driving control module 21 are installed in the vehicle 2. When the vehicle-mounted device 20 receives the movement command from the server 30, the automatic driving control module 21 automatically controls the driving of the vehicle 2 to move the vehicle 2 to the destination of the passenger 4b and thereafter to the delivery destination of the left-behind belongings. To enable the user 4 to check his or her belongings left behind in the vehicle 2, the vehicle-mounted device 20 sends an image of the interior of the vehicle 2 captured by an in-vehicle camera 214 of the vehicle 2 to the mobile terminal 40 of the user 4 through the server 30.

The vehicle-mounted device 20, the server 30, and the mobile terminal 40 can communicate with each other through a network 5, which is composed of optical communication lines or the like. The server 30 is connected to the network 5 through, for example, a gateway or the like (not illustrated). The vehicle-mounted device 20 and the mobile terminal 40 are connected to the network 5 through, for example, wireless base stations 6 or the like.

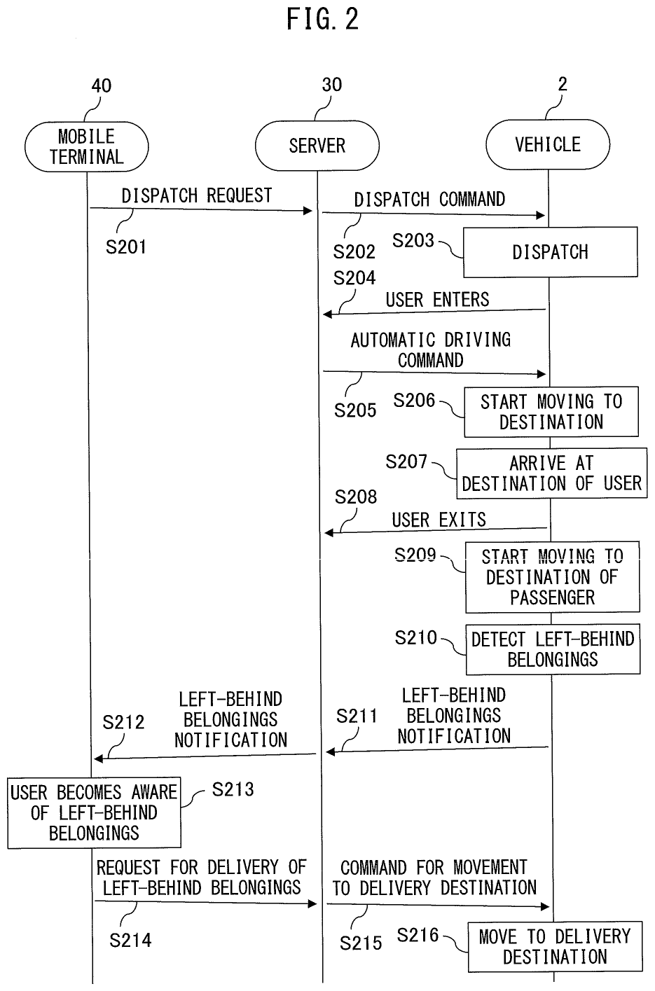

FIG. 2 is a sequence diagram showing an example of a left-behind belongings delivery process for moving the vehicle 2 to a delivery destination of left-behind belongings, in the left-behind belongings delivery support system 1 according to the first embodiment. In the sequence diagram of FIG. 2, the server 30, the vehicle 2, and the mobile terminal 40 communicate through the network 5.

The server 30 receives the identification information of the user 4, information regarding the present location and destination of the user 4, and the like, together with a dispatch request, from the mobile terminal 40 of the user 4 who wishes to use the mobility service (step S201). The identification information of the user 4 is, for example, a user number assigned to the user 4 of the mobility service. The present location and destination of the user 4 are designated by, for example, facility names, addresses, or combinations of latitude and longitude.

The server 30 retrieves vehicles 2 that are present within a certain distance from the present location of the user 4, and selects an available vehicle 2 from the retrieved at least one vehicle 2. The server 30 sends a dispatch command to the vehicle 2 to move the vehicle 2 to the present location of the user 4 (step S202). Note that, when the vehicles 2 offer a ride sharing service or the like, other passengers 4b may already be riding in the vehicles 2. In this case, for example, the server 30 may select, from the retrieved at least one vehicle 2, a vehicle 2 containing other passengers 4b who are travelling to a destination that is in the same direction as the destination of the user 4.

Upon receiving the dispatch command from the server 30, the automatic driving control module 21 of the vehicle 2 moves the vehicle 2 to the present location of the user 4, which is received together with the dispatch command (step S203).

When the user 4 enters the dispatched vehicle 2, the automatic driving control module 21 of the vehicle 2 detects the entry of the user 4 into the vehicle 2 by, for example, the in-vehicle camera 214, and informs the server 30 as such (step S204). The user 4 himself or herself, instead of the automatic driving control module 21 of the vehicle 2, may inform the server 30 of his or her entry into the vehicle 2 by operation of the mobile terminal 40.

Upon receiving confirmation that the user 4 has entered the vehicle 2, the server 30 generates a driving route from the present location of the vehicle 2 to the destination of the user 4. Alternatively, for example, a car navigation system of the vehicle 2 may generate a driving route based on the information regarding the present location and destination of the user 4, which is received together with the dispatch command. Note that, when the vehicle 2 offers ride sharing services, a driving route from the present location of the vehicle 2 to the nearest destination, from among the destinations of the other passengers 4b already riding in the vehicle 2 and the destination of the user 4, is generated.

The server 30 sends the driving route to the automatic driving control module 21 of the vehicle 2, as necessary, and commands the automatic driving control module 21 of the vehicle 2 to automatically drive the vehicle 2 along the driving route (step S205). The automatic driving control module 21 of the vehicle 2 thereby starts the automatic driving of the vehicle 2 to the destination along the driving route (step S206). While the automatic driving control module 21 is driving the vehicle 2 automatically, the vehicle-mounted device 20 regularly sends position information representing the present position to the server 30.

When the vehicle 2 arrives at the destination of the user 4 (step S207) and the user 4 exits the vehicle 2, the automatic driving control module 21 of the vehicle 2 detects the exit of the user 4 from the vehicle 2 by, for example, the in-vehicle camera 214, and informs the server 30 as such (step S208). The user 4 himself or herself, instead of the automatic driving control module 21 of the vehicle 2, may inform the server 30 of his or her exit from the vehicle 2 by operation of the mobile terminal 40.

Next, the automatic driving control module 21 of the vehicle 2 automatically controls the driving of the vehicle 2, and starts moving to a destination of the other passenger 4b (step S209). The passenger 4b who is riding in the vehicle 2 thereafter finds the user's belongings left behind in the vehicle 2. The passenger 4b who has found the user's belongings stores the left-behind belongings in, for example, a lost-and-found box provided in the vehicle 2. The vehicle-mounted device 20 detects that the left-behind belongings have been stored in the lost-and-found box (step S210), and sends a left-behind belongings notification, which represents the detection of the left-behind belongings in the vehicle 2, to the server 30 (step S211).

Upon receiving the left-behind belongings notification from the vehicle-mounted device 20, the server 30 sends the received left-behind belongings notification to the mobile terminal 40 of the user 4 who has already exited the vehicle 2 (step S212). As a result, the user 4 can view the left-behind belongings notification displayed on the mobile terminal 40, and becomes aware that he or she has left his or her belongings behind in the vehicle 2 (step S213).

When the user 4 who has become aware of the left-behind belongings wishes to quickly retrieve the left-behind belongings, the user 4 operates the mobile terminal 40 to send a delivery request for moving the vehicle 2 to the delivery destination of the left-behind belongings to the server 30, together with information regarding the delivery destination of the left-behind belongings (step S214). The information regarding the delivery destination of the left-behind belongings may be designated based on information regarding the address and the like of the user 4 stored by the server 30 in a memory in advance, instead of being designated by the user 4 by operating the mobile terminal 40.

The server 30 that has received the request for delivery of the left-behind belongings calculates an expected delivery time when the vehicle 2 is expected to arrive at the delivery destination of the left-behind belongings. When, for example, the expected delivery time is on the same day, the server 30 sends a movement command to move the vehicle 2 to the delivery destination of the left-behind belongings, to the vehicle-mounted device 20, together with the information regarding the delivery destination (step S215). Thereafter the server 30 sends the expected delivery time to the mobile terminal 40.

Conversely, when the expected delivery time is on the next or a later day, the server 30 does not send a movement command to the delivery destination to the vehicle-mounted device 20, and sends a notification that the left-behind belongings cannot be delivered to the delivery destination of the left-behind belongings, to the mobile terminal 40. In this case, the left-behind belongings are delivered to, for example, a lost-and-found office or the like.

When the vehicle-mounted device 20 receives the command to move to the delivery destination of the left-behind belongings from the server 30, the automatic driving control module 21 automatically controls the driving of the vehicle 2 to move the vehicle 2 to the destination of the passenger 4b and thereafter to the delivery destination of the left-behind belongings (step S216).

When it is not necessary that the user 4 who has become aware of his or her left-behind belongings retrieve the left-behind belongings quickly, the user 4 may not send a request for delivery of the left-behind belongings to the server 30. In this case, the left-behind belongings are delivered to, for example, the lost-and-found office or the like. When the left-behind belongings are not especially important, the user 4 may send a command for discarding the left-behind belongings to the server 30. In this case, the belongings are discarded later by a manager of the vehicle 2 or the like.

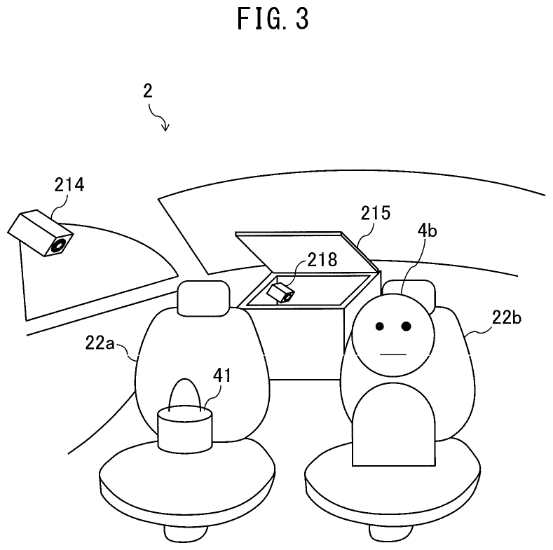

FIG. 3 is a drawing showing an example of the state of a compartment of the vehicle 2 according to the first embodiment. In the compartment of the vehicle 2 illustrated in FIG. 3, personal belongings 41 of the user 4 who has exited the vehicle 2 are left behind in a seat 22a. The other passenger 4b is sitting in another seat 22b in the passenger compartment of the vehicle 2. A lost-and-found box 215 for storing the left-behind belongings 41 therein is provided near the trunk of the vehicle 2. The lost-and-found box 215 has a camera 218 to image the inside of the lost-and-found box 215.

The vehicle-mounted device 20 regularly displays a message that “in case of finding someone's belongings left behind, please put the left-behind belongings in the lost-and-found box 215” or the like. Alternatively, the vehicle-mounted device 20 may regularly announce the message using a speaker of the vehicle 2. Therefore, after the user 4 has exited the vehicle 2, the user's belongings 41 left behind on the seat 22a are stored by the passenger 4b in the lost-and-found box 215.

When the vehicle-mounted device 20 detects that the belongings 41 have been stored in the lost-and-found box 215 by, for example, the camera 218 installed in the lost-and-found box 215, the vehicle-mounted device 20 sends a left-behind belongings notification to the server 30. The left-behind belongings notification may include an image of the belongings 41 captured by the camera 218 of the lost-and-found box 215. The user 4 can recognize his or her belongings 41 left behind in the vehicle 2.

Upon closing the lid of the lost-and-found box 215 in which the belongings 41 are stored, the vehicle-mounted device 20 may automatically lock the lost-and-found box 215. This protects the belongings 41 from theft. In this case, the vehicle-mounted device 20 may include a password to unlock the lost-and-found box 215 in the left-behind belongings notification. Therefore, when the vehicle 2 arrives at the delivery destination of the belongings 41, the user 4 can unlock the lost-and-found box 215 by inputting the password included in the left-behind belongings notification and take his or her belongings 41 out of the lost-and-found box 215.

Alternatively, the vehicle-mounted device 20 may send a signal to the mobile terminal 40 of the user 4 to display an unlock button for unlocking the lost-and-found box 215 on a touch display of the mobile terminal 40. The user 4 can thereby unlock the lost-and-found box 215 by operating the unlock button displayed on the touch display of the mobile terminal 40.

The vehicle-mounted device 20 may detect that the belongings 41 have been stored in the lost-and-found box 215 by, for example, sensing an opening and closing operation of the lid of the lost-and-found box 215 using a switch that is turned on and off in synchronization with the opening and closing operation of the lid, instead of by the camera 218. Alternatively, the vehicle-mounted device 20 may detect that the belongings 41 are stored in the lost-and-found box 215 by detecting that the output of a weight sensor provided in the bottom of the lost-and-found box 215 exceeds a predetermined threshold value, due to the weight of the belongings 41.

Instead of the lost-and-found box 215, a left-behind belongings notification button to be operated by the passenger 4b to notify the server 30 of the detection of the belongings left behind in the vehicle 2 may be provided in the vehicle 2. The left-behind belongings notification button may be, for example, a button displayed on a display device of the vehicle 2 or the touch display of the mobile terminal 40 of the passenger 4b.

When another passenger 4b is not riding in the vehicle 2, after the user 4 has exited the vehicle 2, the vehicle-mounted device 20 may detect the belongings 41 left behind in the vehicle 2 by processing a video captured by the in-vehicle camera 214. In this case, the vehicle-mounted device 20 compares an image before the user 4 enters the vehicle 2 with an image after the user 4 has exited the vehicle 2. When an object that was not present before the entry of the user 4 is detected in the vicinity of the seats 22a and 22b and the like, the belongings 41 are determined to be detected.

More specifically, the vehicle-mounted device 20 can use machine learning techniques to detect an object from an image. For example, the vehicle-mounted device 20 can use a detector such as, for example, a DNN (deep neural network) that is taught to detect an object from an image, when the image is inputted. The vehicle-mounted device 20 inputs an image before the entry of the user 4 and an image after the exit of the user 4 into the detector, and compares objects in the image before the entry of the user 4 outputted from the detector with objects in the image after the exit of the user 4 outputted from the detector. When an object that was not present in the image before the entry of the user 4 is detected in the image after the exit of the user 4, the vehicle-mounted device 20 can determine that the belongings 41 have been detected.

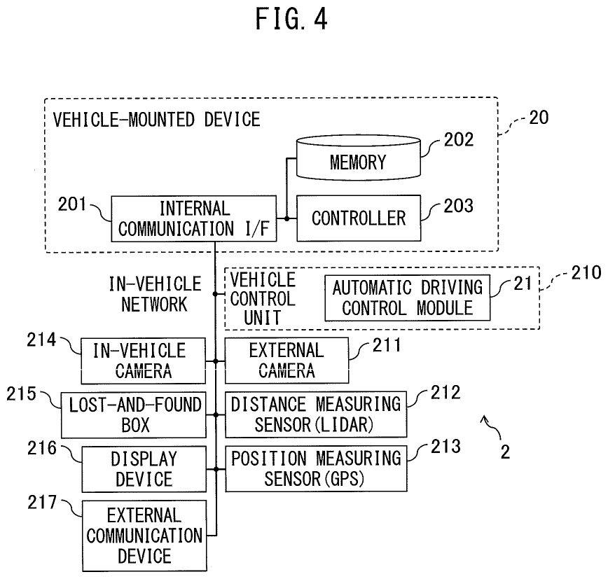

FIG. 4 is a hardware configuration diagram of the vehicle 2 according to the first embodiment. The vehicle 2 includes the vehicle-mounted device 20, a vehicle control unit 210, an external camera 211, a distance measuring sensor 212, a position measuring sensor 213, the in-vehicle camera 214, the lost-and-found box 215, a display device 216, and an external communication device 217 that are connected to each other through an in-vehicle network. The vehicle 2 further includes the automatic driving control module 21. The in-vehicle network is, for example, a network that is in conformity with CAN (controller area network) standards.

When the vehicle-mounted device 20 receives, from the server 30, a command to move to a delivery destination of left-behind belongings, the automatic driving control module 21 automatically controls the driving of the vehicle 2 to move the vehicle 2 to the delivery destination of the left-behind belongings. The vehicle-mounted device 20 has an internal communication interface (I/F) 201, a memory 202, and a controller 203 that are connected to each other through signal lines.

The internal communication I/F 201 is a communication I/F circuit through which the vehicle-mounted device 20 communicates with other vehicle-mounted devices of the vehicle 2 via the in-vehicle network.

The memory 202 includes a recording medium such as an HDD (hard disk drive), an optical recording medium, or a semiconductor memory, and stores computer programs executed by the controller 203. The memory 202 stores data generated by the controller 203, data received by the controller 203 from the other vehicle-mounted devices of the vehicle 2 through the in-vehicle network, and the like. The memory 202 stores information regarding the destination of the user 4, the delivery destination of the left-behind belongings, a driving route, and the like received from the server 30.

The controller 203 is one or more processors and peripheral circuits thereof that execute computer programs for control and calculation in the vehicle-mounted device 20.

The automatic driving control module 21 automatically controls the driving of the vehicle 2. The automatic driving control module 21 is configured so that, for example, the performance and function of automatic driving control can be updated. Therefore, the performance and function of the automatic driving control module 21 can be optimized in accordance with the mobility service offered by the vehicle 2. Note that, in applications in which improvements in the performance and function of the automatic driving control module 21 are not particularly necessary, the automatic driving control module 21 need not necessarily be configured so as to be updatable.

The vehicle control unit 210 includes at least one automatic driving control module 21, and controls the accelerator, brake, and steering wheel of the vehicle 2 in accordance with control signals outputted from the automatic driving control module 21. The vehicle control unit 210 transfers signals outputted from the external camera 211, distance measuring sensor 212, and position measuring sensor 213, which are described later, to the automatic driving control module 21.

The external camera 211 captures and outputs a video of the surroundings of the vehicle 2. The video captured by the external camera 211 is used by the automatic driving control module 21 to automatically control the driving of the vehicle 2. The external camera 211 is disposed near a windshield of the vehicle 2, for example, with an imaging surface thereof facing toward the outside such that people or objects around the vehicle 2 are captured clearly.

The distance measuring sensor 212 measures and outputs distances to objects that are present ahead of the vehicle 2 on an orientation basis. Distance information measured by the distance measuring sensor 212 is used, in the same manner, by the automatic driving control module 21 to automatically control the driving of the vehicle 2. The distance measuring sensor 212 is, for example, a LIDAR (light detection and ranging) installed in the vehicle 2.

The position measuring sensor 213 generates position information that represents the present location of the vehicle 2, and outputs the position information to the vehicle-mounted device 20. The position information generated by the position measuring sensor 213 is used by the automatic driving control module 21 to automatically control the driving of the vehicle 2, and is also sent to the server 30 through the network 5 so that the server 30 can understand the present location of the vehicle 2. The position measuring sensor 213 is, for example, a GPS (global positioning system) of the car navigation system installed in the vehicle 2.

The in-vehicle camera 214 captures a video of the interior of the vehicle 2 and outputs the video to the vehicle-mounted device 20. The video captured by the in-vehicle camera 214 is sent to the mobile terminal 40 of the user 4 through the server 30 so that the user 4 can recognize his or her belongings left behind in the vehicle 2, in addition to being used by the vehicle-mounted device 20 to detect the left-behind belongings in the vehicle 2. A plurality of in-vehicle cameras 214 may be disposed in the vehicle 2. To clearly image the interior of the vehicle 2, as illustrated in FIG. 3, the in-vehicle camera 214 is disposed, for example, on the ceiling in front of or in right or left front of the seats 22a and 22b of the vehicle 2, or the like.

The lost-and-found box 215 accommodates belongings left behind in the vehicle 2. A plurality of lost-and-found boxes 215 may be disposed in the vehicle 2. The lost-and-found box 215 is disposed near the trunk of the vehicle 2, as illustrated in FIG. 3, so as not to occupy significant space in the passenger compartment of the vehicle 2. Alternatively, the trunk of the vehicle 2 may be used as the lost-and-found box 215.

The display device 216 is controlled by the controller 203 of the vehicle-mounted device 20 to display guidance such as, for example, “in case of finding someone's belongings left behind, please put the left-behind belongings in the lost-and-found box 215” or the like. Instead of the display device 216, a speaker, which announces the guidance to the interior of the vehicle under the control of the controller 203 of the vehicle-mounted device 20, or the like may be used. Therefore, after the user 4 has exited the vehicle 2, the passenger 4b stores the user's belongings 41 left behind on the seat 22a in the lost-and-found box 215.

The external communication device 217 is an in-vehicle terminal having a wireless communication function, and is, for example, an in-vehicle navigation system or a DCM (data communication module), as described in the non-patent literature (TOYOTA MOTOR CORPORATION, Mobility Service-specific EV “e-Palette Concept” [retrieved on Aug. 31, 2018], Internet <URL: https://newsroom.toyota.co.jp/jp/corporate/20508200.html>). The external communication device 217 is connected to the network 5 through the wireless base station 6 by, for example, accessing the wireless base station 6, which is connected to the network 5 through a gateway (not illustrated) or the like.

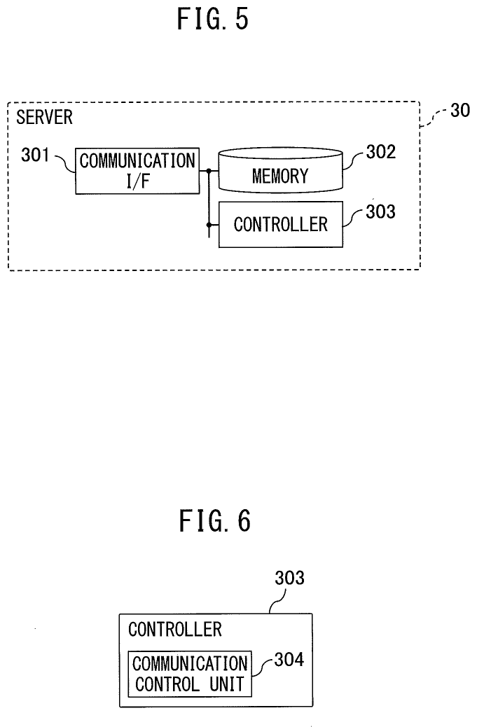

FIG. 5 is a hardware configuration diagram of the server 30 according to the first embodiment. The server 30 includes a communication I/F 301, a memory 302, and a controller 303 that are connected to each other through signal lines.

The communication I/F 301, which is an example of the communication device, is a communication I/F circuit for connecting the server 30 to the network 5 through, for example, a gateway or the like. The communication I/F 301 is configured to be able to communicate with the vehicle-mounted device 20 of the vehicle 2 and the mobile terminal 40 through the network 5.

The memory 302 includes a recording medium such as an HDD (hard disk drive), an optical recording medium, or a semiconductor memory, and stores computer programs executed by the controller 303. The memory 302 stores data generated by the controller 303, data received by the controller 303 through the network 5, and the like. The memory 302 stores information regarding the destination of the user 4, the delivery destination of left-behind belongings, and the like received from the mobile terminal 40. The memory 302 stores the type, version, or the like of the automatic driving control module 21 of the vehicle 2, as an example of information regarding the vehicle 2. The memory 302 stores the identification information, address, and the like of the user 4, as an example of information regarding the user 4.

FIG. 6 is a functional block diagram of the controller 303 of the server 30 according to the first embodiment. The controller 303 is one or more processors and peripheral circuits thereof that execute computer programs for control and calculation in the server 30. The controller 303 has a communication control unit 304. The communication control unit 304 is realized as, for example, a software module or firmware to which computer programs are written.

Upon receiving a request for delivery of belongings left behind in the vehicle 2 from the mobile terminal 40 through the communication I/F 301, the communication control unit 304 sends a movement command to move the vehicle 2 to the delivery destination of the left-behind belongings, to the vehicle-mounted device 20 through the communication I/F 301.

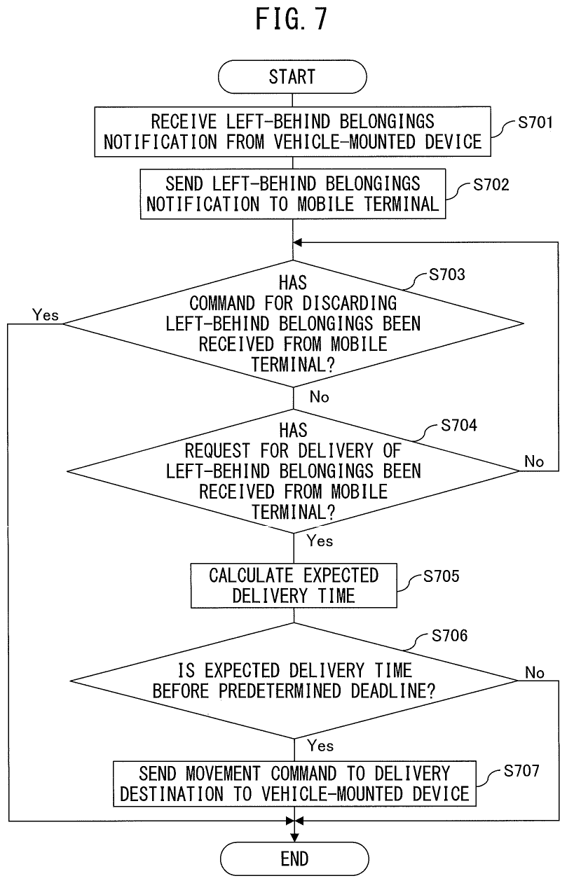

FIG. 7 is a flowchart showing an example of the left-behind belongings delivery process for moving the vehicle 2 to the delivery destination of left-behind belongings, in the server 30 according to the first embodiment. The communication control unit 304 performs the left-behind belongings delivery process in accordance with the following flowchart. Descriptions regarding contents that are the same as the sequence diagram of FIG. 2 have been omitted.

Upon receiving a left-behind belongings notification from the vehicle-mounted device 20 of the vehicle 2 through the communication I/F 301 (step S701), the communication control unit 304 sends the received left-behind belongings notification to the mobile terminal 40 of the user 4 who has last exited the vehicle 2 through the communication I/F 301 (step S702). Alternatively, the communication control unit 304 may send the left-behind belongings notification to the mobile terminals 40 of all the users 4 who have exited the vehicle 2 on the same day.

The communication control unit 304 determines whether or not a command for discarding the left-behind belongings has been received from at least one of the users 4 to which the left-behind belongings notification has been sent (step S703). When the command for discarding the left-behind belongings has been received (YES in step S703), the communication control unit 304 stores the reception of the discard command in the memory 302, and then ends the left-behind belongings delivery process. In this case, the left-behind belongings are discarded later by the manager of the vehicle 2 or the like, in accordance with the discard command stored in the memory 302.

Conversely, when a command for discarding the left-behind belongings has not been received (NO in step S703), the communication control unit 304 determines whether or not a request for delivery of the left-behind belongings has been received from the mobile terminal 40 of at least one of the users 4 to which the left-behind belongings notification has been sent (step S704). When a request for delivery of the left-behind belongings has not been received (NO in step S704), the communication control unit 304 repeats steps S703 and S704 until either a discard command or a delivery request is received from the mobile terminal 40. When neither a discard command nor a delivery request has been received after a predetermined period of time (for example, 10 minutes) has lapsed since the sending of the left-behind belongings notification, the communication control unit 304 may end the left-behind belongings delivery process.

Upon receiving a request for delivery of the left-behind belongings (YES in step S704), the communication control unit 304 calculates an expected delivery time when the vehicle 2 can be moved to the delivery destination of the left-behind belongings (step S705). The expected delivery time is, for example, when no passengers 4b are riding in the vehicle 2, a time at which the vehicle 2 can arrive at the delivery destination of the left-behind belongings from the current time. Conversely, when a passenger 4b is riding in the vehicle 2, the expected delivery time is a time at which the vehicle 2 can arrive at the delivery destination of the left-behind belongings, after the vehicle 2 is moved to the destination of the passenger 4b.

Next, the communication control unit 304 determines whether or not the expected delivery time is before a predetermined deadline (step S706). The predetermined deadline is, for example, midnight of the same day. When the expected delivery time is before the predetermined deadline (YES in step S706), the communication control unit 304 sends a movement command to move the vehicle 2 to the delivery destination of the left-behind belongings, to the vehicle-mounted device 20 of the vehicle 2 (step S707). The communication control unit 304 then ends the left-behind belongings delivery process. The vehicle 2 thereby delivers the left-behind belongings to the delivery destination. In this case, the communication control unit 304 may send the expected delivery time to the mobile terminal 40.

Conversely, when the expected delivery time is after the predetermined deadline (NO in step S706), the communication control unit 304 ends the left-behind belongings delivery process without sending a movement command for moving the vehicle 2 to the delivery destination of the left-behind belongings to the vehicle-mounted device 20. In this case, the communication control unit 304 may send a notification that the left-behind belongings cannot be delivered to the delivery destination to the mobile terminal 40.

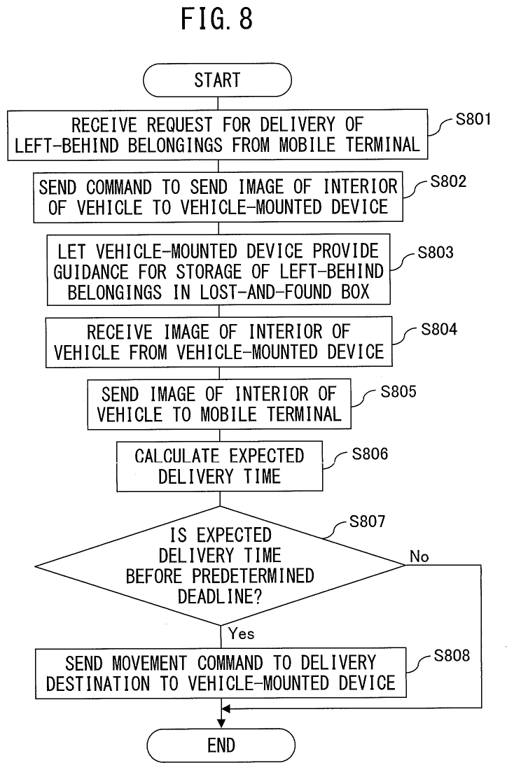

FIG. 8 is a flowchart showing another example of the left-behind belongings delivery process for moving the vehicle 2 to the delivery destination of left-behind belongings, in the server 30 according to the first embodiment. The flowchart of FIG. 8 shows the left-behind belongings delivery process in a case where the user 4 himself or herself becomes aware of left-behind belongings, before he or she receives a left-behind belongings notification from the vehicle-mounted device 20 of the vehicle 2.

When the communication control unit 304 receives a request for delivery of left-behind belongings from the mobile terminal 40 of the user 4, before receiving a left-behind belongings notification from the vehicle-mounted device 20 (step S801), the communication control unit 304 sends a command for making the vehicle-mounted device 20 send an image of the interior of the vehicle 2, to the vehicle-mounted device 20 (step S802). The communication control unit 304 sends a command to provide guidance for the storage of the left-behind belongings in the lost-and-found box 215 to the vehicle-mounted device 20 or the mobile terminal 40 of the passenger 4b (step S803). Therefore, the passenger 4b can store the user's belongings 41 left behind on the seat 22a in the lost-and-found box 215.

Next, when the communication control unit 304 receives the image of the interior of the vehicle 2 from the vehicle-mounted device 20 through the communication I/F 301 (step S804), the image of the interior of the vehicle 2 is sent to the mobile terminal 40 through the communication I/F 301 (step S805). The user 4 can thereby check his or her belongings 41 left behind in the vehicle 2. When the left-behind belongings are not especially important, the user 4 who has checked his or her left-behind belongings may send a command for discarding the left-behind belongings to the server 30. In this case, the server 30 cancels the movement of the vehicle 2 to the delivery destination of the left-behind belongings.

Descriptions regarding steps S806 to S808, which are the same as steps S705 to S707 of FIG. 7, have been omitted.

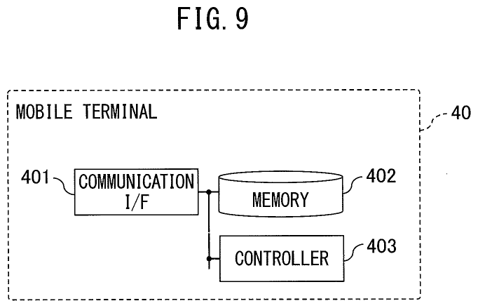

FIG. 9 is a hardware configuration diagram of the mobile terminal 40 according to the first embodiment. The mobile terminal 40 includes a communication I/F 401, a memory 402, and a controller 403 that are connected to each other through signal lines.

The communication I/F 401 is a communication I/F circuit for connecting the mobile terminal 40 to the network 5 through, for example, a gateway or the like. The communication OF 401 is configured to be able to communicate with the server 30 through the network 5.

The memory 402 includes a recording medium such as an HDD (hard disk drive), an optical recording medium, or a semiconductor memory, and stores computer programs executed by the controller 403. The memory 402 stores data generated by the controller 403, data received by the controller 403 through the network 5, and the like.

The controller 403 is one or more processors and peripheral circuits thereof that execute computer programs for control and calculation in the mobile terminal 40.

As described above, the left-behind belongings delivery support apparatus according to the present embodiment includes the communication device that is configured to be able to communicate with the vehicle-mounted device installed in the vehicle that is under the automatic driving control and the mobile terminal of the user of the vehicle. When the left-behind belongings delivery support apparatus receives a request for delivery of the user's belongings left behind in the vehicle from the mobile terminal through the communication device, the left-behind belongings delivery support apparatus sends a movement command to move the vehicle to the delivery destination of the left-behind belongings, to the vehicle-mounted device through the communication device.

Therefore, by moving the vehicle that is under the automatic driving control to the delivery destination of the left-behind belongings, the left-behind belongings delivery support apparatus according to the present embodiment can support the quick delivery of the user's belongings left behind in the vehicle.

The above embodiment is merely a practical example of embodiment of the present invention, and the technical scope of the present invention is not limited thereby. The present invention can be carried out in various forms without departing from the technical principles or major features thereof.

According to another modification example, the left-behind belongings delivery support apparatus may calculate a delivery fee to be charged to the user 4, in accordance with a time required for delivery of the left-behind belongings. For example, when the delivery destination of the left-behind belongings is along the driving route to the destination, the delivery fee may be free. Therefore, the user 4 can determine whether or not to make a request for delivery of his or her left-behind belongings, in accordance with whether or not the left-behind belongings are important, whereby the delivery of the left-behind belongings can be efficiently carried out.

When the left-behind belongings cannot be delivered by moving the vehicle 2, as in a case where the user 4 who has left his or her belongings behind in the vehicle 2 has an overseas address, the left-behind belongings delivery support apparatus may automatically request another server to deliver the left-behind belongings by ship or air.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A left-behind belongings delivery support apparatus comprising:
a communication device configured to be able to communicate with a vehicle-mounted device installed in a vehicle that is under automatic driving control and a mobile terminal of a user of the vehicle; and
a processor configured to send, when a request for delivery of belongings left behind in the vehicle is received from the mobile terminal through the communication device, a movement command for moving the vehicle to a delivery destination of the left-behind belongings, to the vehicle-mounted device through the communication device.

2. The left-behind belongings delivery support apparatus according to claim 1, wherein, upon receiving the delivery request, the processor sends a command for making the vehicle-mounted device send an image of an interior of the vehicle, to the vehicle-mounted device through the communication device, whereby the processor receives the image from the vehicle-mounted device through the communication device, and sends the received image to the mobile terminal through the communication device.

3. The left-behind belongings delivery support apparatus according to claim 1, wherein when the processor receives a left-behind belongings notification indicating that the left-behind belongings have been detected in the vehicle from the vehicle-mounted device through the communication device, the processor sends the left-behind belongings notification to the mobile terminal through the communication device.

4. The left-behind belongings delivery support apparatus according to claim 3, wherein the left-behind belongings notification is issued when the left-behind belongings have been stored in a lost-and-found box, and the left-behind belongings notification includes an image of the inside of the lost-and-found box and a password to unlock the lost-and-found box.

5. The left-behind belongings delivery support apparatus according to claim 4, wherein when the processor receives the delivery request, before receiving the left-behind belongings notification, the processor sends a command, to the vehicle-mounted device through the communication device, to let the vehicle-mounted device provide guidance for the storage of the left-behind belongings in the lost-and-found box.

6. The left-behind belongings delivery support apparatus according to claim 1, wherein when the processor receives a command for discarding the left-behind belongings from the mobile terminal through the communication device, the processor does not send the movement command to the vehicle-mounted device.

7. A left-behind belongings delivery support system comprising a vehicle-mounted device installed in a vehicle that is under automatic driving control, a mobile terminal of a user of the vehicle, and a server communicatably connected to the vehicle-mounted device and the mobile terminal through a network, wherein
the mobile terminal sends a request for delivery of belongings left behind in the vehicle to the server,
upon receiving the delivery request, the server sends a movement command to move the vehicle to a delivery destination of the left-behind belongings, to the vehicle-mounted device, and
upon receiving the movement command, the vehicle-mounted device moves the vehicle to the delivery destination of the left-behind belongings.

8. A left-behind belongings delivery support method comprising the steps of:
through a communication device configured to be able to communicate with a vehicle-mounted device installed in a vehicle that is under automatic driving control and a mobile terminal of a user of the vehicle, receiving a request for delivery of belongings left behind in the vehicle from the mobile terminal through the communication device; and thereafter
sending a movement command to move the vehicle to a delivery destination of the left-behind belongings, to the vehicle-mounted device through the communication device.
